(19) United States
(12) Patent Application Publication
(10) Pub. No.: US 2007/0006467 A1
(43) Pub. Date: Jan. 11, 2007

(54) Cutter head for a trimmer

(75) Inventor: Dieter Angstenberger, Leutenbach (DE)

Correspondence Address: ROBERT W. BECKER & ASSOCIATES;Suite B, 707 Highway 66 East, Tijeras, NM, 87059, US

(73) Assignee: Andreas Stihl AG & Co. KG, Waiblingen (DE)

(21) Appl. No.: 11/483,114

(22) Filed: Jul. 7, 2006

(30) Foreign Application Priority Data
Jul. 7, 2005 (DE) 10 2005 031 778.2

(51) Int. Cl. B26B 7/00

(52) U.S. Cl. 30/276; 30/347

(57) ABSTRACT

A cutter head for a trimmer and adapted to be rotatingly driven about an axis of rotation. The cutter head has at least one cutting filament, whereby with reference to the axis of rotation the cutting filament has a radially outer cutting portion and a clamping portion disposed between the cutting portion and a retention end. The cutter head has an approximately U-shaped receiving passage that includes a first leg, a second leg, and a clamping section disposed between the legs. The retention end of the cutting filament is adapted to be guided through the first leg, and the cutting portion is adapted to be guided through the second leg. The clamping section of the receiving passage has a wedge shape that tapers toward the retention end of the cutting filament and is adapted to effect securement of the clamping portion in the clamping section.

The instant application should be granted the priority date of Jul. 7, 2005 the filing date of the corresponding German patent application 10 2005 031 778.2.

### BACKGROUND OF THE INVENTION

The present invention relates to cutter head for a trimmer.

Motorized scythes or trimmers of known construction have a drive motor, for example in the form of an internal combustion engine, that by means of a shaft that is mounted in a guide tube drive a cutter head that is rotatable about an axis of rotation. The cutter head is equipped with a cutting filament that, when the cutter head rotates, rotates in a given direction of rotation and, as a consequence of the centrifugal forces that occur, is thereby oriented approximately radially relative to the axis of rotation. During its rotational movement, the cutting filament defines a cutting circle. Provided in the region of the cutter head is a protective shield that at least partially covers the cutting filament over the cutting circle.

To mow various plants such as grass or the like, the trimmer, in a customary operating position, is oriented such that the cutting circle is disposed approximately parallel to the surface that is to be cut. In the plane of the cutting circle, the rotating cutting filament severs the plants.

The cutting filament can be wound onto a supply spool in the cutter head. As the cutting filament becomes used up, it is unwound from the spool until the required length is provided. Alternatively, a predetermined length of cutting filament is provided that is secured to the cutter head via a radially inner retention end. As the radially outer cutting portion of the cutting filament is used up, it is replaced as an individual or spare part. To ensure a safe operation, a reliable securement of the retention end is necessary, which at the same time must take into account ease of replaceability.

U.S. Pat. No. 5,615,543 discloses a cutting head for a trimmer, and is embodied as a cup-shaped support having two individual cutting filaments. Provided in a peripheral wall of the cup-shaped carrier are two approximately radially extending bores for each cutting filament. The cutting portion of the cutting filament is guided through one of the bores, while the retention end is guided through the adjacent bore. The retention end of the cutting filament is melted to provide a widened head. For installation, the cutting filament is first introduced radially from the outside toward the inside through the first bore, until the head of the retention end comes to rest positively in a corresponding recess and forms an axial securement. Subsequently, the cutting filament is bent in a U-shaped manner, and a cutting portion thereof is introduced radially from the inside toward the outside through the adjacent bore. Threading the filament through the bores is cumbersome. The positive securement that is provided by the melted filament head is subjected to high stresses and can lead to a passing of the filament head through the receiving means. Tearing in a region of the head is also a possibility.

It is therefore an object of the present invention to improve a cutter head of the aforementioned general type in such a way that it is easy to exchange or replace individual cutting filaments while at the same time a strong, reliable securement is possible.

### BRIEF DESCRIPTION OF THE DRAWINGS

This object, and other objects and advantages of the present invention, will appear more clearly from the following specification in conjunction with the accompanying schematic drawings, in which:

FIG. 1 is an overall view of a trimmer in a customary operating position and having a protective shield and a rotating cutter head;

FIG. 2 is an enlarged, perspective interior view of the cutter head of FIG. 1 with molded components secured to its peripheral portion for respectively receiving a cutting filament;

FIG. 3 is a radially outer end view of the molded component of FIG. 2;

FIG. 4 is a radially inner end view of the molded component;

FIG. 5 is a longitudinal cross-sectional view of the molded component showing details of the configuration of a U-shaped receiving passage that is formed therein; and

FIG. 6 is a cross-sectional view, rotated by 90° relative to FIG. 5, showing details of clamping surfaces that are disposed in a V-shaped manner.

### SUMMARY OF THE INVENTION

The cutter head of the present application for a trimmer includes at least one cutting filament, wherein with reference to the axis of rotation of the cutter head the cutting filament has a radially outer cutting portion and a clamping portion that is disposed between the cutting portion and a retention end of the cutting filament; the cutter head has an approximately U-shaped receiving passage that includes a first leg, a second leg, and a clamping section that is disposed between the first and second legs, wherein the retention end of the cutting filament is adapted to be guided through the first leg of the receiving passage; the cutting portion of the cutting filament is adapted to be guided through the second leg of the receiving passage, and the clamping section of the receiving passage has a wedge shape that tapers in a direction toward the retention end of the cutting filament and is adapted to effect securement of the clamping portion of the cutting filament in the clamping section of the receiving passage of the cutter head.

The U-shaped receiving passage provides a user an easily recognizable U-shaped filament course in the region of the retention end of the cutting filament. In the context of the present application, U-shaped designates a deflection of greater than 90°. As a result of the deflection, when a pulling force is exerted upon the cutting portion of the cutting filament, such as occurs, for example, due to centrifugal force during operation, the clamping portion of the cutting filament is drawn into the clamping section of the receiving passage. The wedge shape, which tapers in the direction of the retention end, automatically clamps the clamping portion of the cutting filament, as a result of which the cutting filament is reliably held. The cutting filament does not have to be provided with a head or some other type of positive retention means, and can be installed as a part that is pre-cut to length or can be cut to length by the operator or user. Introducing the cutting filament into the receiving passage is significantly simplified. Clamping of the cutting filament in the clamping section of the receiving passage is reliable and gentle on the material. The danger of ripping or the formation of impressions is prevented.

Pursuant to a preferred embodiment, the first leg and the second leg of the U-shaped receiving passage are disposed at least approximately parallel to one another and expediently extend in the radial direction relative to the axis of rotation of the cutter head. The parallel arrangement of the two legs effects a deflection of the cutting filament of approximately 180°, as a result of which a high clamping effect is achieved in the interposed clamping portion. As a consequence of the radial orientation of the passage legs, the centrifugal forces that occur during operation result directly in a pulling force upon the clamping portion into the tapering wedge.

Pursuant to an expedient embodiment, the cutting filament is freely movably guided in at least one of the two legs, and preferably in both of the legs, of the U-shaped receiving passage. In this context, freely movable predominantly means an axial free displaceability, which enables an easy introduction or threading-in of the cutting filament. In particular, a free movability in the radial direction of the cutting filament can also be provided since the receiving passage is oversized relative to the cross-section of the cutting filament. In conjunction with the wedge shape of the clamping section of the receiving passage, different filament diameters can be inserted into the same cutter head, whereby thinner cutting filaments merely pass somewhat further into the wedge shape of the clamping section. This has no disadvantageous influence upon the holding force. Cutting filaments of different diameters are reliably held to the same extent.

Pursuant to a preferred further development, the first leg of the U-shaped receiving passage that receives the retention end of the cutting filament is open in the longitudinal direction at its free end. This enables the retention end to extend through to such an extent that it projects to the outside. To release the clamping connection, or to remove a ripped-off retention end, the retention end can be pressed in in the longitudinal direction and can be manually removed.

The second leg of the U-shaped receiving passage that adjoins the cutting portion is advantageously embodied as a receiving groove that with reference to the radial direction is open along its longitudinal axis. To install a new cutting filament, it is merely necessary to insert its retention end into the appropriate leg of the receiving passage. Subsequently, the cutting portion of the cutting filament can be bent, without any further cumbersome threading-in, and can be pressed into the open receiving groove. Disassembly or removal is effected in the reverse direction. The replacement process is considerably simplified.

The aforementioned receiving groove expediently has an approximately L-shaped cross-section with an open cross-section leg and a closed cross-section leg, whereby the closed cross-section leg, proceeding from the open cross-section leg, faces away from the first leg of the U-shaped receiving passage. During installation of a new cutting filament, the cutting portion, which is bent with a narrow radius, is pressed in through the open cross-section leg. By utilizing the elastic restoring forces of the cutting filament, which is provided with a certain rigidity, the cutting filament portion that is bent in a U-shaped manner spreads or springs open. Proceeding from the retention end, the cutting portion is pressed into the closed cross-section leg in a spring-like manner, where it is secured from sliding out unintentionally due to the engaging, material-specific spring force.

The clamping section of the receiving passage can be formed by cut edges that are disposed in a V-shaped manner, by corrugations, or the like, and is preferably formed by planar clamping surfaces that are disposed in a wedge-shaped manner. The clamping effect is effected by pressure distributed over the surface, avoiding point-type loads. There is no loss of strength in the clamping portion of the cutting filament. Even under high and continuous operating loads, a reliable securement is ensured while avoiding the formation of tears. For a reliable, manually straightforward and releasable clamping, an expedient opening angle of the wedge shape is between 4° and 7°.

Pursuant to a preferred further development, the receiving passage is formed in a shaped or molded component that is secured to a support member of the cutter head as a separate component. The molded component can be economically produced as a mass produced individual component having a complex geometry, and is easy to individually replace if it becomes worn. For this purpose, the molded component is preferably secured to the support member in a positively engaging yet removable manner, and is inserted all together, via a retaining flange, radially from the inside toward the outside into the support member. This permits the option of undertaking replacement of the cutting filaments with a molded component that has been removed, and subsequently reinserting the molded component into the support member with the new cutting filament held therein. The support member of the cutter head is expediently provided with a mounting or introduction groove that merges into the receiving groove of the molded component. In this connection, the cutting filament can also be easily replaced in the installed state of the molded component since the cutting portion of the cutting filament is withdrawn out of the mounting groove and the receiving groove or is introduced into them.

Further specific features of the present invention will be described in detail subsequently.

### DESCRIPTION OF SPECIFIC EMBODIMENTS

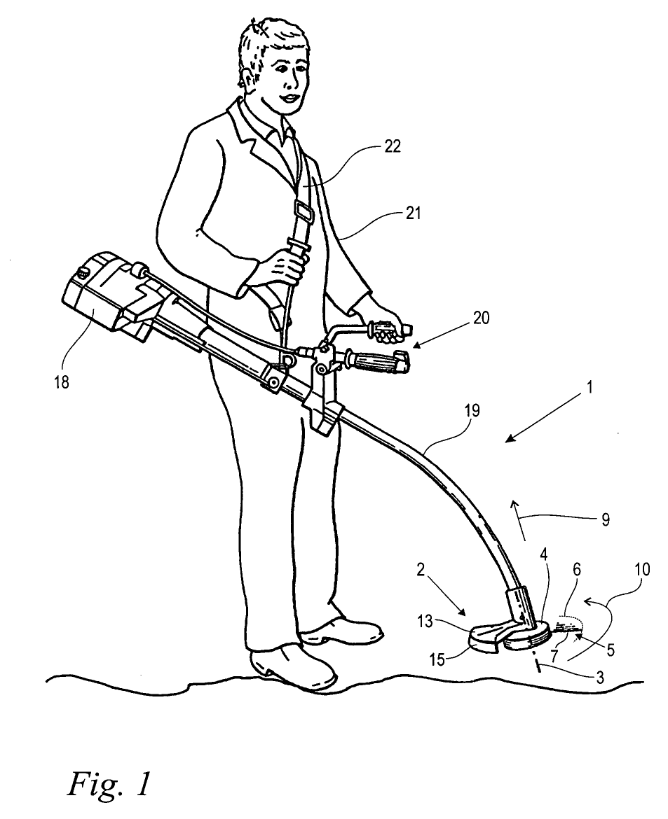

Referring now to the drawings in detail, the overall view of FIG. 1 shows an operator 21 carrying a brushcutter or trimmer 1 in a customary operating position by means of a carrying strap 22. The trimmer 1 includes a guide tube 19, on one end of which is disposed a motor unit 18 and on the opposite end of which is disposed a cutter head 4. Extending within the guide tube 19 is a non-illustrated drive shaft, by means of which a similarly non-illustrated drive motor rotatingly drives the cutter head 4. To guide the trimmer 1, a handle unit 20 is provided on the guide tube 19 and has disposed on it control elements for controlling the drive motor.

The cutter head 4 is equipped with a cutting filament 5 that during operation rotates together with the cutter head 4 about an axis of rotation 3 in a direction of rotation that is indicated by the arrow 10. The flexible cutting filament 5, which is made of polymeric material, is oriented approximately radially relative to the axis of rotation 3 as a consequence of the centrifugal forces that result during the rotation and, via a cutting portion 7 of the cutting filament 5, describes a cutting circle 6 that is indicated by dotted lines.

A protective shield 2 that is secured to the apparatus is disposed in the region of the cutter head 4 on the associated end of the guide tube 19. The protective shield 2 includes a support portion 13 that extends approximately radially relative to the axis of rotation 3, and toward the outer side of which a peripheral wall 15 in the form of a cylindrical section is angled off.

In the illustrated, customary operating position of the trimmer 1, the axis of rotation 3 is disposed approximately vertically relative to the ground surface that is to be cut, whereupon a plane of the cutting circle 6 extends approximately parallel to such ground surface. The axis of rotation 3 prescribes an upright or axial direction that is indicated by the arrow 9 and is parallel to the axis of rotation 3. The flat support portion 13 covers the cutting circle 6 of the cutting filament 5 upwardly in the upright direction 9 over an angular range that faces the operator 21. Over the same angular range, the cutting circle 6 is covered radially outwardly by the peripheral wall 15.

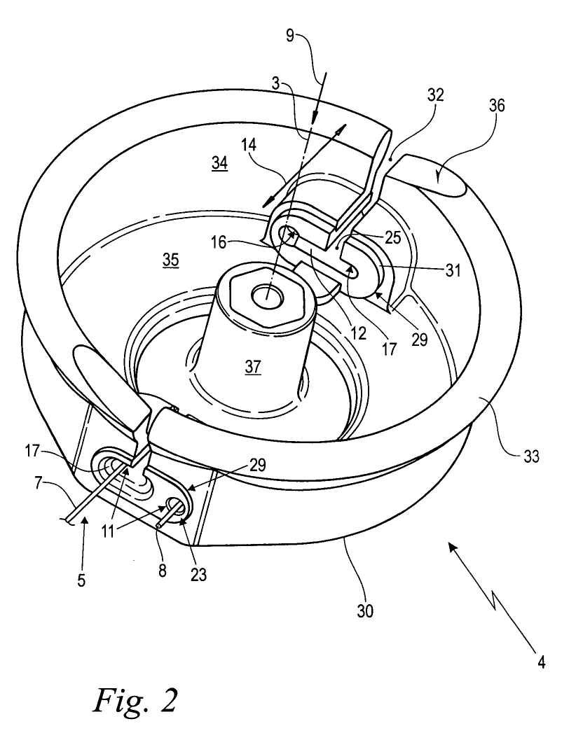

FIG. 2 shows a perspective inner view of the cutter head 4 of FIG. 1 from below. The cutter head 4 includes a cup-shaped support member 30 having a circular disc shaped end wall 35 which is adjoined, in the peripheral region, by a cylindrical peripheral wall 34 that extends from the end wall 35 counter to the upright direction 9. The cup-shaped support member 30 is open downwardly, whereby the peripheral wall 34 is delimited by a circumferential, rounded rim 33. In the middle, the support member 30 is provided with a hub 37 that in turn is provided for securement of the cutter head 4 on the non-illustrated drive shaft of the trimmer 1 (FIG. 1), whereby the cutter head 4 is disposed concentrically relative to the axis of rotation 3.

The radial direction relative to the axis of rotation 3 is indicated by the double arrow 14. With reference to the radial direction 14, two oppositely disposed shaped or molded components 29 are inserted into the peripheral wall 34 of the support member 30. For this purpose, the molded components 29 are provided on their radially inner side with a retaining flange 31 and are inserted in a positively engaging manner into a corresponding receiving means of the peripheral wall 34 so as to be removable from the inside. In this connection, each retaining flange 31 rests flat against the corresponding receiving means and secures the molded component 29 from sliding out radially as a result from centrifugal forces that occur. The molded components 29 can also be formed in one piece with, and of the same material as, the support member 30, i.e. can be monolithic with the support member.

The two identical molded components 29 are provided for each receiving a separate cutting filament 5, whereby to facilitate illustration, only one of the cutting filaments 5 is illustrated. It can also be expedient to uniformly distribute three or more cutting filaments 5 over the periphery, along with a corresponding number of molded components 29.

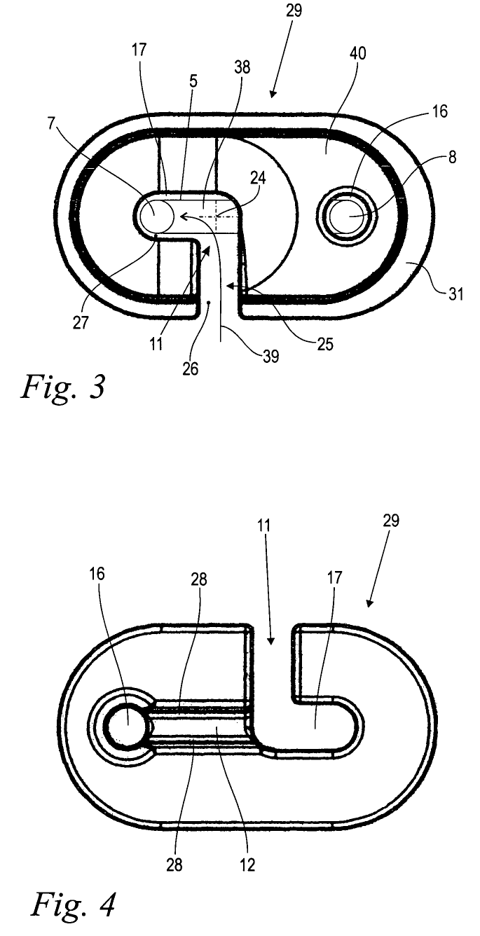

Formed in the molded component 29 is a U-shaped receiving passage 11 for the respective cutting filaments 5; the geometrical details of the receiving passage 11 will be described in greater detail subsequently in conjunction with FIGS. 3 to 6. The U-shaped receiving passage 11 includes two legs 16, 17, which extend parallel to one another and are oriented in the radial direction 14, and a clamping section 12 that is disposed between the legs 16, 17 and extends approximately in the peripheral direction. A retention end 8 of the cutting filament 5 is guided through the first leg 16 and projects radially outwardly out of a free end 23 of the first leg 16. The cutting portion 7 of the cutting filament 5 is guided through the second leg 17 and similarly projects radially outwardly with a prescribed length, which is not illustrated here, whereby the length of the cutting portion 7 conforms to the cutting circle 6 that is to be formed (FIG. 1).

The second leg 17 is embodied as a receiving groove 25 that is open in a direction counter to the upright direction 9; the receiving groove 25 merges in a flush manner into a mounting groove 32 of the peripheral wall 34 that is similarly open in a direction counter to the upright direction 9. In the region of the mounting groove 32, the rim 33 of the peripheral wall 34 is provided with an inclined surface 36 that in the peripheral direction and in the axial direction extends at an angle into the mounting groove 32. To install a new cutting filament 5, when it is oriented in a radial direction it can be introduced along the inclined surface 36 into the mounting groove 32; from there, the cutting filament 5 can be introduced into the receiving groove 25, which also extends in the radial direction 14. Further details regarding the assembly or installation process will be described in greater detail subsequently.

FIG. 3 shows a frontal view of the molded component 29 of FIG. 2 from the outside. As can be seen, the retaining flange 31 extends about a base body 40 of the molded component 29. It can also be expedient to provide only one section or a plurality of individual sections of the retaining flange 31. The base body 40 and the circumferential retaining flange 31 have an essentially oval shape in the view shown.

The first leg 16 of the receiving passage 11 is embodied as a circular through bore in which a portion of the filament that adjoins the retention end 8 of the cutting filament 5 is guided with play so as to be freely movable. The second leg 17 of the U-shaped receiving passage 11, through which is guided the cutting portion 7 of the cutting filament 5, has a longitudinal axis 24 that extends parallel to the longitudinal axis of the first leg 16 and in addition is oriented in the radial direction 14 (FIG. 2). The second leg 17 is embodied as a receiving groove 25 that with reference to the radial direction is open toward the longitudinal axis 24. The receiving groove 25 has an approximately L-shaped cross-section including an open cross-section leg 26 and a closed cross-section leg 27. Proceeding from the open cross-section leg 26, the closed cross-section leg 27 faces away from the first leg 16 of the U-shaped receiving passage 11. The portion of the cutting filament 5 that adjoins the cutting portion 7 and is held in the second leg 17 is also movably held in the second leg 17 so as to be free of play, and permits a freely axial and lateral movement.

To install a new cutting filament 5, the retention end 8, with reference to the illustration of FIG. 3, is first inserted from the rear, in other words radially from the inside, into the first leg 16 until, in conformity with the illustration of FIG. 2, the retention end 8 peeks or projects out of the free end 23 of the first leg 16. Subsequently, the cutting filament 5 is bent in a U-shaped manner, forming a clamping portion 38 that adjoins the retention end 8, until the cutting portion 7 extends approximately parallel to the filament portion of the retention end 8 but extends in the opposite direction. The clamping portion 38 of the cutting filament 5 extends between the filament portion that adjoins the retention end 8 and the filament portion that adjoins the cutting portion 7. In the bent state, the filament portion that adjoins the cutting portion 7 can be pressed from the outside into the L-shaped receiving groove 25 along the arrow 39, whereby manually only a movement along the open cross-section leg 26 is required. The flexible yet residually rigid cutting filament 5, due to its elastic restoring forces, spreads open and presses the filament portion that adjoins the cutting portion 7 into the closed cross-section leg 27, thereby ensuring a positive engagement. A removal of the cutting filament 5 is effected in the opposite direction.

FIG. 4 shows the molded component 29 of FIG. 3 in a radial view from the inside to the outside. In conjunction with the view from the other side of FIG. 3, one can see that the two legs 16, 17 of the receiving passage 11 are continuous in the radial direction 14 (FIG. 2). Extending between the two legs 16, 17 are two clamping surfaces 28 of the clamping section 12; the clamping surfaces 28 are angled toward one another in a wedge-shaped manner and serve for receiving the clamping portion 38 of the cutting filament 5 (FIG. 3) in a clamping manner.

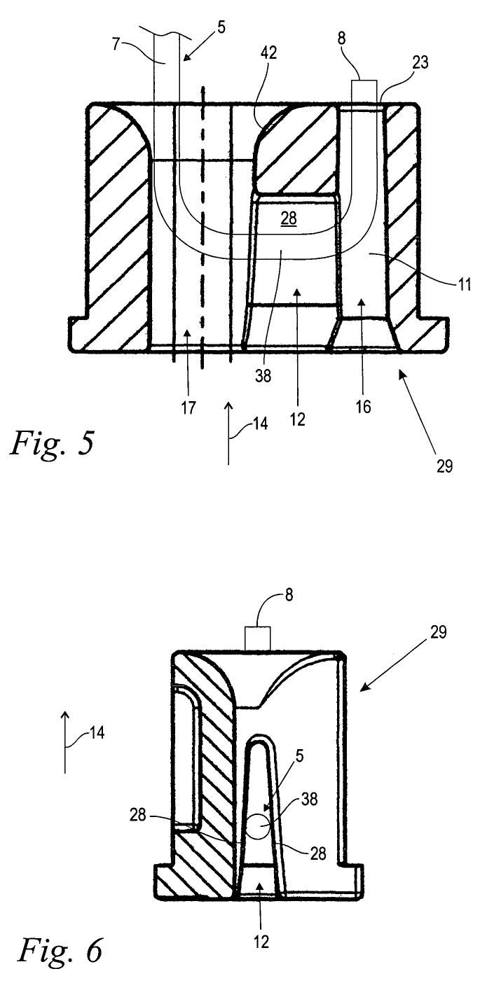

From the longitudinal cross-sectional illustration of the molded component 29 of FIG. 5 one can see that in the installed state the cutting filament 5 is bent in a U-shaped manner, whereby its bent shape is prescribed by the approximately U-shaped course of the receiving passage 11 with its two legs 16, 17 and the clamping section 12 that is disposed between the legs. The portions of the cutting filament 5 that are held in the molded component 29, with the exception of the clamping portion 38, are disposed with play in the receiving passage 11. The cutting filament 5 is held in the clamping section 12 merely by the clamping of its clamping portion 38; in this connection, the surface of the cutting filament 5 is clamped between the planar clamping surfaces 28 of the clamping section 12, which are disposed in a wedge-shaped manner. The retention end 8 of the cutting filament 5 projects out of the free end 23 of the first leg 16. The first leg 16 can also be embodied as a blind hole into which the retention end 8 is inserted in the radial direction 14. The cutting portion 7 similarly projects in the radial direction 14 out of the associated second leg 17 of the receiving passage 11. By pulling on the cutting portion 7 in the radial direction 14, the clamping portion 38 of the cutting filament 5 is drawn into the clamping section 12 of the receiving passage 11.

FIG. 6 shows a cross-sectional view of the molded component 29 that is rotated by 900 from the illustration of FIG. 5. It can be seen that the two clamping surfaces 28 are disposed in the shape of a wedge that tapers in the radial direction 14, i.e. in the direction of the retention end 8. The clamping portion 38 of the cutting filament 5 is held in a clamped manner between the clamping surfaces 28 of the clamping section 12, with the clamping surfaces 28 being disposed in a V-shaped manner. The opening angle between the two planar clamping surfaces 28 is preferably from 4° to 7°, and in the illustrated embodiment is approximately 7°. In this angular range, on the one hand a reliable clamping of the clamping portion 38 of the cutting filament 5 can be observed, whereby different diameters of the clamping portion 38 have no influence upon the clamping effect, but merely mean that the clamping portion 38 slides to a greater or lesser extent in the radial direction 14 between the two planar, linearly extending clamping surfaces 28. On the other hand, due to the angular range that is selected, the clamping effect is not excessive, so that when it is desired to replace the cutting filament 5, the clamping of the clamping portion 38 can be released manually without the need to use any tools.

The specification incorporates by reference the disclosure of German priority document 10 2005 031 778.2 filed 07 July 2005.

The present invention is, of course, in no way restricted to the specific disclosure of the specification and drawings, but also encompasses any modifications within the scope of the appended claims.

What I claim is:

1. A cutter head for a trimmer, comprising:
a cutter head that is adapted to be rotatingly driven about an axis of rotation, wherein said cutter head is provided with at least one cutting filament, wherein with reference to said axis of rotation of said cutter head said cutting filament has a radially outer cutting portion and a clamping portion that is disposed between said cutting portion and a retention end of said cutting filament, wherein said cutter head has an approximately U-shaped receiving passage that includes a first leg, a second leg, and a clamping section that is disposed between said first leg and said second leg, wherein said retention end of said cutting filament is adapted to be guided through said first leg of said receiving passage, wherein said cutting portion of said cutting filament is adapted to be guided through said second leg of said receiving passage, and wherein said clamping section of said receiving passage has a wedge shape that tapers in a direction toward said retention end of said cutting filament and is adapted to effect securement of said clamping portion of said cutting filament in said clamping section of said receiving passage of said cutter head.

2. A cutter head according to claim 1, wherein said first leg and said second leg of said U-shaped receiving passage are disposed at least approximately parallel to one another.

3. A cutter head according to claim 1, wherein at least one of said legs of said U-shaped receiving passage extends approximately in a radial direction relative to said axis of rotation.

4. A cutter head according to claim 1, wherein said cutting filament is freely movably guided in at least one of said legs of said U-shaped receiving passage.

5. A cutter head according to claim 1, wherein said first leg of said U-shaped receiving passage that receives said retention end of said cutting filament is open in a longitudinal direction at a free end of said first leg.

6. A cutter head according to claim 1, wherein said second leg of said U-shaped receiving passage that is adapted to guide said cutting portion of said cutting filament is embodied as a receiving groove that with reference to a radial direction is open along a longitudinal axis of said second leg.

7. A cutter head according to claim 6, wherein said receiving groove has an approximately L-shaped cross-section with an open cross-section leg and a closed cross-section leg, and wherein proceeding from said open cross-section leg said closed cross-section leg faces away from said first leg of said U-shaped receiving passage.

8. A cutter head according to claim 1, wherein said clamping section of said receiving passage is formed by planar clamping surfaces that are disposed in a wedge-shaped manner.

9. A cutter head according to claim 1, wherein said wedge shape of said clamping section of said receiving passage has an opening angle of between 4° and 7°.

10. A cutter head according to claim 1, wherein said receiving passage is formed in a molded component that is secured to a support member of said cutter head as a separate component.

11. A cutter head according to claim 10, wherein said molded component is inserted on said support member of said cutter head in a positively engaging yet removable manner.

12. A cutter head according to claim 11, wherein said molded component is provided with a retaining flange and is inserted radially from the inside toward the outside into said support member.

13. A cutter head according to claim 10, wherein said support member (30) of said cutter head is provided with an introduction groove that merges into a receiving groove of said molded component.
